(19) United States
(12) Patent Application Publication
(10) Pub. No.: US 2008/0170485 A1
(43) Pub. Date: Jul. 17, 2008

(54) Optical recording medium

(75) Inventors: Koji Mishima, Tokyo (JP); Hidetake Itoh, Tokyo (JP); Takashi Kikukawa, Tokyo (JP)

Correspondence Address: OLIFF & BERRIDGE, PLC, P.O. BOX 320850, ALEXANDRIA, VA, 22320-4850, US

(73) Assignee: TDK CORPORATION, TOKYO (JP)

(21) Appl. No.: 12/003,913

(22) Filed: Jan. 3, 2008

(30) Foreign Application Priority Data
Jan. 15, 2007 (JP) 2007-6477

(51) Int. Cl. G11B 7/00

(52) U.S. Cl. 369/100

(57) ABSTRACT

The optical recording medium includes a first information layer including a first recording film having an extinction coefficient of 0.4 or less at a wavelength of a laser beam used for recording and reproducing, and a second information layer including a second recording film consisting essentially of the same constituent elements as those of the first recording film and having an extinction coefficient of 0.4 or less. Among the first and second information layers, the first information layer is located further away from a laser beam-incident surface than the second information layer located closest to the incident surface. The first information layer further includes a light absorbing film having an extinction coefficient of 1.5 or more at the wavelength of the laser beam, the extinction coefficient of the light absorbing film being greater than that of the first recording film.

### BACKGROUND OF THE INVENTION

1. Field of the Invention

The present invention relates to an optical recording medium including a plurality of information layers.

2. Description of the Related Art

Optical recording media such as CDs (Compact Discs) and DVDs (Digital Versatile Discs) have been widely utilized as information recording media. In addition, in recent years, the use of optical recording media known as Blu-ray Discs (registered trademark) and HD DVDs (registered trademark) has become widespread. In such optical recording media, a blue or blue-violet laser beam having a wavelength of 405 nm (within the range of 375 to 435 nm) is used for recording and reproducing, so that a larger amount of information can be recorded in comparison to conventional media. Note that, in such optical recording media, tracks are formed with a track pitch within the range of 0.1 to 0.5 μm, and more specifically, with a track pitch of 0.32 μm for Blu-ray Discs and 0.40 μm for HD DVDs.

Optical recording media are broadly classified into a ROM (Read Only Memory) type to which data cannot be added or rewritten, a rewritable type to which data can be rewritten, and a write-once type to which data can be written only once.

In write-once type optical recording media, data is recorded by projecting a laser beam onto an information layer to form recording marks which have a reflectivity that is different from that of a space portion therearound. At the same time, the space portion around each recording mark is also irradiated with the recording laser beam. However, since the amount of the recording laser beam projected onto the space portion is small, the reflectivity of the space portion is the same as the reflectivity of the information layer before it was irradiated with the laser beam. Moreover, in the write-once type optical recording media, data is reproduced by projecting a laser beam onto the information layer and detecting the difference in reflectivity between the recording mark and the space portion therearound using a photodetector.

In some cases, the information layer is composed of a recording film only. However, in most cases, in addition to the recording film, a dielectric film for protecting the recording film is provided on one side or both sides of the recording film. When the information layer has, in addition to the recording film, an additional layer such as the dielectric film described above, a material having an extinction coefficient which is less than that of the recording film is often used as the material forming the additional layer in order to reduce the amount of the laser beam that is absorbed by the additional layer as much as possible. For example, the extinction coefficient of the material used to form the recording film is in the range of approximately 0.5 to 3.0, and a material having an extinction coefficient in the range of approximately 0.00 to 0.10 is often used as the material forming the dielectric layer.

In addition to this, a reflective layer is often provided on the side of the information layer, the side furthest away from the laser beam incident surface. A metal such as Al or Ag is often used as the material forming the reflective layer, and the extinction coefficient of the material forming the reflective layer is 2.0 or more.

When an optical recording medium is provided with a plurality of information layers, the recording capacity thereof can be increased correspondingly. When data is recorded on a write-once type optical recording medium provided with a plurality of information layers, the data can be selectively recorded on a target information layer by focusing a recording laser beam on the target information layer. Furthermore, data can be selectively reproduced from a target information layer by focusing a reproducing laser beam on the target information layer.

It is also expected that, in optical recording media known as Blu-ray Discs and HD DVDs, the recording capacity is further increased by providing a plurality of information layers.

In write-once type optical recording media provided with such a plurality of information layers, it is preferable that, when each of the information layers is irradiated with a recording laser beam at the same output power level, good recording marks be formed equally in all the information layers.

In addition to this, it is preferable that, when each of the plurality of information layers is irradiated with a reproducing laser beam at the same output power level, the light beams reflected from the respective information layers be detected by a photodetector such that the intensities thereof are close to each other.

However, a lower information layer is irradiated with a laser beam through an upper information layer. In this instance, the upper information layer is an information layer disposed on the side close to the surface on which the laser beam is incident, and the lower information layer is an information layer disposed on the side further away from the laser beam-incident surface. A part of the laser beam is absorbed by the upper information layer, so that the amount of the laser beam reaching the lower information layer decreases correspondingly.

Therefore, when the output power level of a recording laser beam projected onto the lower information layer is the same as that of a recording laser beam projected onto the upper information layer, the amount of the recording laser beam reaching the lower information layer is less than the amount of the recording laser beam reaching the upper information layer. Hence, good recording marks may not be formed in the lower information layer.

Also, when the output power level of a reproducing laser beam projected onto the lower information layer is the same as that of a reproducing laser beam projected onto the upper information layer, the amount of the reproducing laser beam reaching the lower information layer is less than the amount of the reproducing laser beam reaching the upper information layer. Furthermore, the beam reflected from the lower information layer reaches a photodetector through the upper information layer, and therefore a part of the reflected beam is also absorbed by the upper information layer. Therefore, when the output power levels of the reproducing laser beams projected onto the lower and upper information layers are the same, and the reflectivities of the lower and upper information layers are the same, the value of the reflectivity of the lower information layer as detected by the photodetector is less than that of the upper information layer as detected by the photodetector.

The optical recording media known as Blu-ray Discs and HD DVDs have a high recording density, so that high recording-reproducing accuracy is required. Therefore, there is a strong demand to reduce the difference in recording sensitivity between the plurality of information layers as well as the difference in reflectivity detected by the photodetector between the plurality of information layers.

In view of the above, a write-once type optical recording medium is known in which, as the material forming the recording film of a lower information layer, a material is used that allows recording marks to be formed therein using a recording laser beam with an output power level that is less than that required for the material forming the recording film of an upper information layer. Moreover, a write-once type optical recording medium is known in which the thickness of the recording film of an upper information layer is less than the thickness of the recording film of a lower information layer (see, for example, Japanese Patent Application Laid-Open No. 2003-266936).

As described above, as the material forming the recording film of a lower information layer, a material may be used that allows recording marks to be formed using a recording laser beam with an output power level that is less than that required for the material forming the recording film of an upper information layer. In this case, even when the output power levels of the recording laser beams projected onto the upper and lower information layers are the same so that the amount of the recording laser beam actually projected onto the lower information layer is less than that projected onto the upper information layer, good recording marks can be formed equally in both the upper and lower information layers.

Moreover, when the thickness of the recording film of an upper information layer is less than the thickness of the recording film of a lower information layer, the amount of the laser beam absorbed by the upper information layer is reduced, so that the effect of increasing the amount of the laser beam reaching the lower information layer can be obtained. Therefore, it is expected that good recording marks are formed equally in both the upper and lower information layers.

Furthermore, when the thickness of the recording film of an upper information layer is less than the thickness of the recording film of a lower information layer, the light beam reflected from the lower recording film is absorbed to a lesser extent by the upper recording film, so that the effect of increasing the amount of the reflected beam reaching a photodetector can be obtained. Therefore, it is expected that the light beams reflected from the lower and upper information layers are detected by the photodetector such that the detected reflectivity values are close to each other even when the output power levels of the reproducing laser beams projected onto the lower and upper recording films are the same.

However, in an optical recording medium in which, as the material forming the recording film of a lower information layer, a material is used that allows recording marks to be formed therein using a recording laser beam with an output power level that is less than that required for the material forming the recording film of an upper information layer, the cost is likely to increase. In particular, the recording films of optical recording media such as Blu-ray Discs and HD DVDs are deposited by, for example, sputtering. Therefore, when the material used to form the recording film of a lower information layer is different from the material used to form the recording film of an upper information layer, a plurality of sputtering target types must be used as the raw materials for the respective recording films. In addition, the sputtering target must be changed for each of the recording films to be deposited. Alternatively, a plurality of deposition equipment units must be provided for each of the recording films to be deposited. The use of a plurality of sputtering target types and the use of a plurality of deposition apparatuses will result in an increase in manufacturing costs. In particular, in an optical recording medium having three or more information layers, three or more sputtering target types may be required, and this may result in a significant increase in manufacturing costs.

Furthermore, in an optical recording medium in which the thickness of the recording film of an upper information layer is less than the thickness of the recording film of a lower information layer, good recording marks having desired characteristics may not be formed in the upper information layer. Generally, when the thickness of a recording film is reduced, the amount of light absorption tends to decrease, and the difference in reflectivity between a recording mark and a space portion therearound tends to decrease. When the thickness of the recording film of an upper information layer is reduced to the extent that the amount of a laser beam reaching a lower information layer is increased to a sufficient level, a recording mark having a reflectivity that is sufficiently different from that of a space portion therearound may not be formed in the upper recording film.

### SUMMARY OF THE INVENTION

In view of the foregoing problems, various exemplary embodiments of this invention provide an optical recording medium which includes a plurality of information layers and in which good recording marks can be formed in each of the information layers. In addition to this, this optical recording medium will contribute to a reduction in manufacturing costs.

Various exemplary embodiments of the invention achieve the above object by an optical recording medium including a plurality of information layers, each information layer including a recording film having an extinction coefficient of 0.4 or less at a wavelength of a laser beam used for recording and reproducing, the recording films consisting essentially of the same constituent elements. Among the information layers, at least one information layer located further away from a laser beam-incident surface than an information layer located closest to the laser beam-incident surface further includes a light absorbing film having an extinction coefficient of 1.5 or less at the wavelength of the laser beam, the extinction coefficient of the light absorbing film being greater than that of the recording film.

The present inventors have first attempted to use, as the materials forming the recording films of an upper information layer and a lower information layer, a common material having an extinction coefficient that is significantly less than that of the materials used to form conventional recording films. Specifically, the inventors have attempted to use, as the materials forming the recording films of the upper and lower information layers, a common material having an extinction coefficient of 0.4 or less. By using the common material having a small extinction coefficient as the material forming the recording films of the upper and lower information layers as described above, the following advantages were expected. A cost reduction might be achieved through use of common materials. Furthermore, since the amount of absorption of a laser beam decreases in the upper information layer, the effect of increasing the amount of the laser beam reaching the lower information layer is obtained without reducing the thickness of the recording film of the upper information layer to less than the thickness of the recording film of the lower information layer. Accordingly, good recording marks might be formed equally in both the information layers.

By using the common material having an extinction coefficient that is significantly less than that of the materials used to form conventional recording films as the material forming the recording films of the upper and lower information layers as described above, the effect of increasing the amount of the laser beam reaching the lower information layer could be obtained. However, recording marks as good as those formed in the upper information layer could not be formed in the lower information layer.

This may be for the following reasons. Although the extinction coefficient of the recording film of the upper information layer is small, the laser beam projected onto the lower information layer is absorbed by the upper information layer to a certain extent. Although the amount of the recording laser beam reaching the lower information layer increases by reducing the extinction coefficient of the recording film of the upper information layer, an irradiated area in the lower information layer is not sufficiently heated because the extinction coefficient of the recording film of the lower information layer is also small. Note that it is conceivable that, since the laser beam projected onto the upper information layer is not absorbed by other information layers, good recording marks can be formed in the upper information layer.

Furthermore, the inventors have attempted to increase the thickness of the recording film of a lower information layer in order to increase the amount of light absorption in the lower information layer. However, since the extinction coefficient of each of the recording films is extremely small, the thickness of the recording film of the lower information layer must be significantly large in order to achieve a sufficient amount of light absorption. In particular, for an optical recording medium including three or more information layers, the thickness of the recording film of a lower information layer must be at least two times the thickness of the recording film of an upper information layer. However, significantly increasing the thickness of the lower information layer is difficult in terms of optical design, and besides, another problem arises with respect to manufacturing productivity.

The present inventors have made further intensive studies and have consequently arrived at a conception of various exemplary embodiments of the present invention. Specifically, a lower information layer includes a recording film and a light absorbing film having an extinction coefficient of 1.5 or less, the extinction coefficient of the light absorbing film being greater than that of the recording film.

As described above, by providing in the lower information layer the recording film and also the light absorbing film having an extinction coefficient that is greater than that of the recording film, the light absorbing film absorbs light even when the extinction coefficient of the recording film of the lower information layer is small in the lower information layer. Therefore, the effect of increasing the amount of light absorption in the lower information layer is obtained, so that an irradiated area in the lower information layer is sufficiently heated. Accordingly, recording marks as good as those formed in the upper information layer can be formed in the lower information layer.

When the extinction coefficient of the light absorbing film is excessively large, an excessive amount of heat is transferred to the surroundings of an irradiated area in the lower information layer, and the formation of good recording marks may be somewhat inhibited. Moreover, when the extinction coefficient of the light absorbing film is excessively large, the amount of light absorption may be greatly changed by just a slight difference in the thickness of the light absorbing film, and therefore the adjustment of sensitivity is difficult. However, since the extinction coefficient of the light absorbing film is 1.5 or less, good recording marks can be reliably formed in the lower information layer.

As described above, in the various exemplary embodiments of the present invention, the lower information layer includes the recording film and the light absorbing film having an extinction coefficient that is greater than that of the recording film. Accordingly, an optical recording medium is provided in which good recording marks can be formed in each of the upper and lower information layers. Thus, various exemplary embodiments of the present invention have been achieved based on a concept that is totally different from the concept applied in the conventional technology. In the conventional technology, when each information layer includes, in addition to the recording film, an additional layer such as a dielectric film, the extinction coefficient of the additional layer is usually less than that of the recording film.

Note that, for an optical recording medium having three or more information layers, a material having a small extinction coefficient is not necessarily used as the material forming the recording film of an information layer placed farthest away from the surface on which a laser beam is incident. When the above relationship is satisfied in two or more information layers other than the above information layer (the information layer placed farthest away from the surface on which the laser beam is incident), good recording marks can be formed in all the information layers, and the effect of reducing manufacturing costs can be obtained to a certain extent.

Accordingly, various exemplary embodiments of this invention provide an optical recording medium, comprising a plurality of information layers, each information layer including a recording film having an extinction coefficient of 0.4 or less at a wavelength of a laser beam used for recording and reproducing, the recording films consisting essentially of the same constituent elements, wherein among the information layers, at least one information layer located further away from a laser beam-incident surface than an information layer located closest to the laser beam-incident surface further includes a light absorbing film having an extinction coefficient of 1.5 or less at the wavelength of the laser beam, the extinction coefficient of the light absorbing film being greater than that of the recording film.

In the present application, the expression “the recording film consists essentially of Bi, O, and M” means that the ratio of the total number of Bi, O, and M atoms in the recording film to the number of all the atoms constituting the recording film is 80% or more. When the recording film consists essentially of Bi, O, and M, it is more preferable that the total number of Bi, O, and M atoms in the recording film be 90% or more of the number of all the atoms constituting the recording film.

Furthermore, in the present application, the expression “the recording film consists essentially of Bi and O” means that the total number of Bi and O atoms in the recording film to the number of all the atoms constituting the recording film is 80% or more. When the recording film consists essentially of Bi and O, it is more preferable that the total number of Bi and O atoms in the recording film to the number of all the atoms constituting the recording film be 90% or more.

According to various exemplary embodiments of the invention, an optical recording medium can be provided which includes a plurality of information layers and in which good recording marks can be formed in each information layer. This optical recording medium contributes to a cost reduction.

### BRIEF DESCRIPTION OF THE DRAWINGS

FIG. 1 is a cross-sectional side view schematically illustrating the structure of an optical recording medium according to a first exemplary embodiment of the present invention;

FIG. 2 is an enlarged cross-sectional side view schematically illustrating the structure of information layers of the optical recording medium;

FIG. 3 is an enlarged cross-sectional side view schematically illustrating the structure of information layers of an optical recording medium according to a second exemplary embodiment of the present invention;

FIG. 4 is an enlarged cross-sectional side view schematically illustrating the structure of information layers of an optical recording medium according to a third exemplary embodiment of the present invention;

FIG. 5 is an enlarged cross-sectional side view schematically illustrating the structure of information layers of an optical recording medium according to a fourth exemplary embodiment of the present invention;

FIG. 6 is an enlarged cross-sectional side view schematically illustrating the structure of information layers of an optical recording medium according to a fifth exemplary embodiment of the present invention; and

FIG. 7 is an enlarged cross-sectional side view schematically illustrating the structure of information layers of an optical recording medium according to a sixth exemplary embodiment of the present invention.

### DETAILED DESCRIPTION OF THE PREFERRED EMBODIMENTS

Hereinafter, preferred exemplary embodiments of the present invention will be described in detail with reference to the drawings.

An optical recording medium 10 according to a first exemplary embodiment of the present invention has a disc-like shape having an outer diameter of approximately 120 mm and a thickness of approximately 1.2 mm, and in this instance, a blue or blue-violet laser beam having a wavelength of approximately 405 nm (within the range of 375 to 435 nm) is used for recording and reproducing.

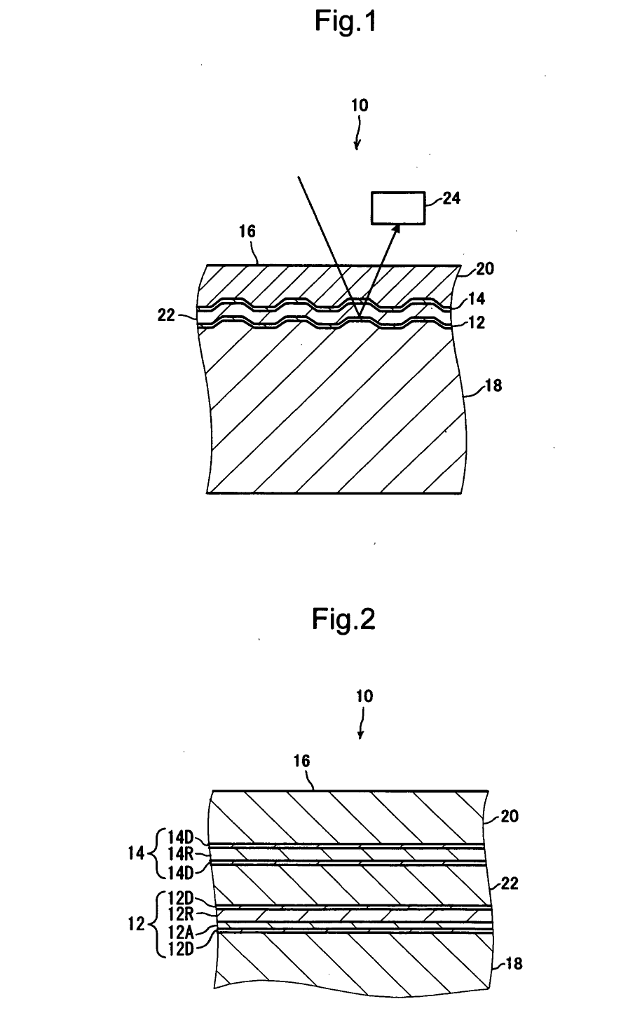

As shown in FIGS. 1 and 2, the optical recording medium 10 includes a first information layer 12 including a first recording film 12R which has an extinction coefficient of 0.4 or less at the wavelength of a laser beam used for recording and reproducing, and a second information layer 14 including a second recording film 14R which consists of constituent elements essentially the same as those of the first recording film 12R and has an extinction coefficient of 0.4 or less at the wavelength of the laser beam used for recording and reproducing. Among the first and second information layers 12 and 14, the first information layer 12 is located further away from a laser beam-incident surface 16 than the second information layer 14 that is located closest to the incident surface 16. The optical recording medium 10 is characterized in that the first information layer 12 further includes a light absorbing film 12A having an extinction coefficient of 1.5 or less, and the extinction coefficient of the light absorbing film 12A is greater than that of the first recording film 12R. The descriptions of the other components will be omitted as appropriate because they do not seem to be particularly important for an understanding of the first exemplary embodiment.

The first and second information layers 12 and 14 are formed over a substrate 18. Furthermore, a cover layer 20 is formed over the second information layer 14 on the side opposite to the substrate 18 side. The incident surface 16 is located on the cover layer 20 on the side opposite to the substrate 18 side. A spacer layer 22 is formed between the first and second information layers 12 and 14. In FIG. 1, reference numeral 24 denotes a photodetector for reproducing.

The first information layer 12 further includes, in addition to the first recording film 12R and the light absorbing film 12A, a dielectric film 12D for protecting the above films on both sides thereof.

Also, the second information layer 14 further includes, in addition to the second recording film 14R, a dielectric film 14D for protecting the above film on both sides thereof.

For example, as the material forming each of the first and second recording films 12R and 14R, any suitable inorganic material may be used which consists essentially of Bi, O, and M (M is at least one element selected from the group consisting of Mg, Ca, Y, Dy, Ce, Tb, Ti, Zr, V, Nb, Ta, Mo, W, Mn, Fe, Zn, Al, In, Si, Ge, Sn, Sb, Li, Na, K, Sr, Ba, Sc, La, Nd, Sm, Gd, Ho, Cr, Co, Ni, Cu, Ga, and Pb) and in which the ratio of the number of O atoms to the total number of all the atoms constituting the material is 62% or more.

Also, a material which consists essentially of Bi and O and in which the ratio of the number of O atoms to the total number of all the atoms constituting the material is 62% or more may be used as the material forming each of the first and second recording films 12R and 14R.

Preferably, the thickness of each of the first and second recording films 12R and 14R is in the range of 10 to 50 nm. Preferably, the thickness of the first recording film 12R is substantially the same as the thickness of the second recording film 14R.

The light absorbing film 12A is disposed so as to come into contact with a surface of the first recording film 12R on the substrate 18 side. Preferably, the material forming the light absorbing film 12A has an extinction coefficient of 0.3 or more at the wavelength of the laser beam used for recording and reproducing. Examples of the material forming the light absorbing film 12A include Fe₂O₃, V₂O₃, V₂O₅, MnO₂, lower oxides such as AlOₓ (0.3<x<1.4), lower nitrides such as AlNₓ (0.2<x<0.9), and FeS. The thickness of the light absorbing film 12A is preferably in the range of 1 to 40 nm.

The extinction coefficient of each of the dielectric films 12D and 14D is less than 0.3 at the wavelength of the laser beam used for recording and reproducing. Examples of the material forming each of the dielectric films 12D and 14D include oxides such as TiO₂, Sio₂, Al₂O₃, ZnO, CeO₂, and Ta₂O₅, nitrides such as SiN, AlN, GeN, and GeCrN, sulfides such as ZnS, and materials containing a mixture thereof, such as a mixture of ZnS and SiO₂, as a main component. The thickness of each of the two dielectric films 12D is preferably in the range of 2 to 20 nm. The thickness of each of the two dielectric films 14D is preferably in the range of 2 to 20 nm.

The substrate 18 has a thickness of approximately 1.1 mm, and a concavo-convex pattern constituting grooves is formed on its surface on the cover layer 20 side. The term “grooves” is generally used to refer to recessed portions used for data recording and reproducing. However, for convenience, in the present application, when portions used for data recording and reproducing are protruding portions protruding toward the cover layer 20 side, the term “grooves” is also used to include the protruding portions. In the first exemplary embodiment, protruding portions protruding toward the cover layer 20 side are the grooves. The grooves are formed with a track pitch within the range of 0.1 to 0.5 μm. Examples of the material forming the substrate 18 include polycarbonate resins, acrylic resins, epoxy resins, polystyrene resins, polyethylene resins, polypropylene resins, silicone resins, fluorine-based resins, ABS resins, and urethane resins.

The cover layer 20 has a thickness of, for example, 30 to 150 μm. Examples of the material forming the cover layer 20 include energy ray-curable transparent or translucent resins such as acrylic-based UV curable resins and epoxy-based UV curable resins. As used herein, the term “energy ray” is used to refer to a generic term of, for example, electromagnetic waves and particle beams, such as ultraviolet rays and electron beams, having the ability to cure a particular resin in a fluid state. As a method for forming the cover layer 20, a resin having fluidity may be applied to the substrate and then cured by projecting energy rays thereonto, or a transparent or translucent film prepared in advance may be applied to the substrate.

The spacer layer 22 has a thickness of, for example, approximately 5 to 90 μm and has on both sides thereof a concavo-convex pattern of grooves similar to that of the substrate 18. Examples of the material forming the spacer layer 22 include energy ray-curable transparent or translucent resins such as acrylic-based UV curable resins and epoxy-based UV curable resins, as in the material forming the cover layer 20.

The first information layer 12 is formed in a concavo-convex pattern following the concavo-convex pattern of the substrate 18. Moreover, the second information layer 14 is formed in a concavo-convex pattern following the concavo-convex pattern of the spacer layer 22.

A description will now be given of the function of the optical recording medium 10.

In the optical recording medium 10, a common material having an extinction coefficient of 0.4 or less at the wavelength of the laser beam used for recording and reproducing is used as the material forming the first recording film 12R of the first information layer 12 and for the material forming the second recording film 14R of the second information layer 14. Therefore, through the use of common materials, the effect of reducing manufacturing costs is expected. In addition to this, even when the thickness of the second recording film 14R of the second information layer 14 is substantially the same as the thickness of the first recording film 12R of the first information layer 12, the amount of absorption of the laser beam in the second information layer 14 is small. Therefore, the effect of increasing the amount of the laser beam reaching the first information layer 12 can be obtained.

Moreover, in the optical recording medium 10, the first information layer 12 includes the first recording film 12R and also the light absorbing film 12A having an extinction coefficient that is greater than that of the first recording film 12R. Therefore, even when the extinction coefficient of the first recording film 12R of the first information layer 12 is small, the light absorbing film 12A absorbs the laser beam, so that the irradiated area in the first information layer 12 is sufficiently heated. Accordingly, recording marks as good as those formed in the second information layer 14 can be formed in the first information layer 12.

When the extinction coefficient of the light absorbing film 12A is excessively large, an excessive amount of heat is transferred to the surroundings of the irradiated area in the first information layer 12, and the formation of good recording marks may be somewhat inhibited. Moreover, when the extinction coefficient of the light absorbing film 12A is excessively large, the amount of light absorption may be greatly changed by a slight difference in the thickness of the light absorbing film 12A, so that the adjustment of sensitivity is difficult. However, since the extinction coefficient of the light absorbing film 12A is 1.5 or less, good recording marks can be reliably formed in the first information layer 12.

Furthermore, since the extinction coefficient of the second recording film 14R of the second information layer 14 is 0.4 or less, the light reflected from the first information layer 12 is also absorbed to a lesser extent by the second information layer 14. Therefore, the effect of increasing the amount of the reflected light reaching a photodetector 24 can be obtained. Accordingly, even when the output power levels of the reproducing laser beams projected onto the first and second information layers 12 and 14 are the same, the light beams reflected from the two information layers can be detected by the photodetector 24 such that the detected reflectivity values are close to each other.

Next, a description will be given of a second exemplary embodiment of the present invention.

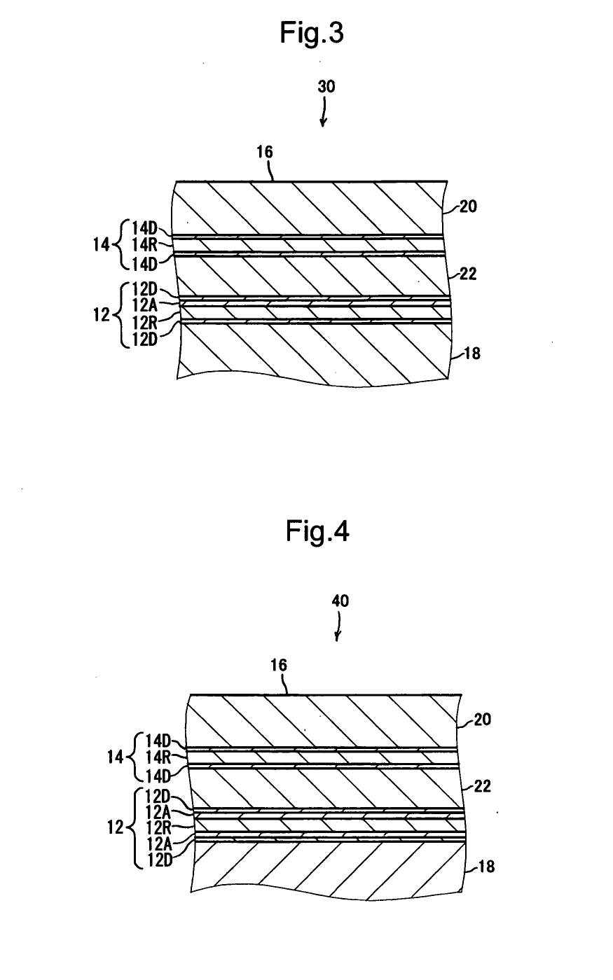

In the optical recording medium 10 according to the first exemplary embodiment, the light absorbing film 12A is disposed so as to come into contact with a surface of the first recording film 12R on the substrate 18 side. However, as shown in FIG. 3, an optical recording medium 30 according to the second exemplary embodiment is characterized in that the light absorbing film 12A is disposed so as to come into contact with a surface of the first recording film 12R on the cover layer 20 side. Since other components are the same as those of the optical recording medium 10, the same reference numerals as in FIGS. 1 and 2 are used, and a redundant description is omitted.

As described above, the light absorbing film 12A is disposed so as to come into contact with the surface of the first recording film 12R on the cover layer 20 side. Even in this case, as in the case in which the light absorbing film 12A is disposed so as to come into contact with the surface of the first recording film 12R on the substrate 18 side, when the extinction coefficient of the first recording film 12R of the first information layer 12 is small, the light absorbing film 12A absorbs the laser beam, so that the irradiated area in the first information layer 12 is sufficiently heated. Accordingly, recording marks as good as those formed in the second information layer 14 can be formed in the first information layer 12.

A description will now be given of a third exemplary embodiment of the present invention.

In the optical recording medium 10 according to the first exemplary embodiment, the light absorbing film 12A is disposed so as to come into contact with the surface of the first recording film 12R on the substrate 18 side. However, as shown in FIG. 4, an optical recording medium 40 according to the third exemplary embodiment is characterized in that the light absorbing film 12A is disposed on both sides of the first recording film 12R so as to come into contact therewith. Since other components are the same as those of the optical recording medium 10, the same reference numerals as in FIGS. 1 and 2 are used, and a redundant description is omitted.

As described above, the light absorbing film 12A is disposed on both the sides of the first recording film 12R so as to come into contact therewith. Even in this case, as in the case in which the light absorbing film 12A is disposed so as to come into contact with the surface of the first recording film 12R on the substrate 18 side, even when the extinction coefficient of the first recording film 12R of the first information layer 12 is small, each light absorbing film 12A absorbs the laser beam, so that the irradiated area in the first information layer 12 is sufficiently heated. Accordingly, recording marks as good as those formed in the second information layer 14 can be formed in the first information layer 12.

A description will now be given of a fourth exemplary embodiment of the present invention.

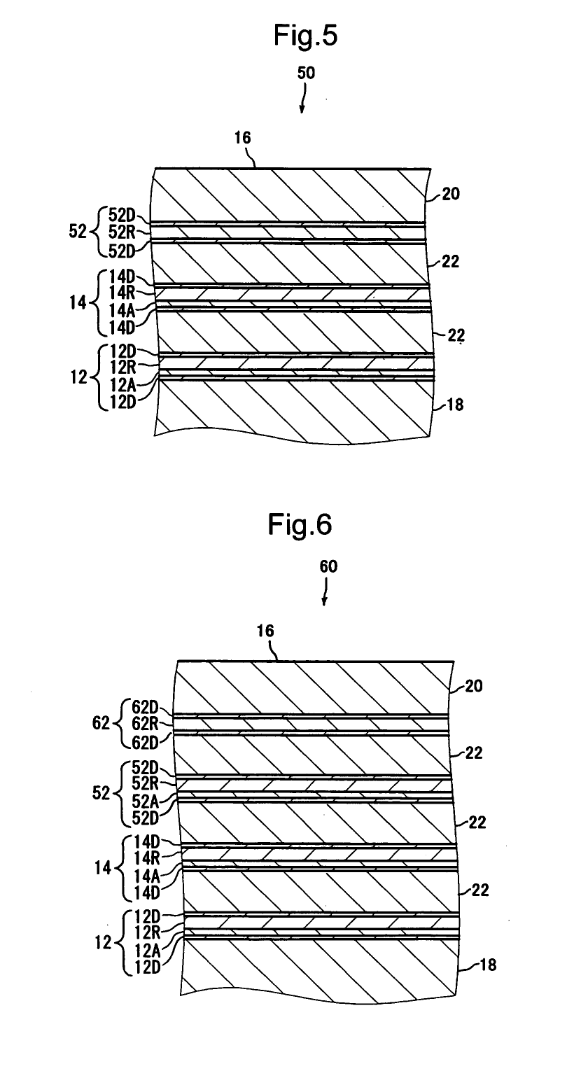

As described above, the optical recording medium 10 according to the first exemplary embodiment is of a two-layer recording type and includes the first and second information layers 12 and 14. However, as shown in FIG. 5, an optical recording medium 50 according to the fourth exemplary embodiment is characterized in that the medium is of a three-layer recording type and includes, in addition to the first and second information layers 12 and 14, a third information layer 52. The third information layer 52 is placed between the second information layer 14 and the cover layer 20.

The third information layer 52 includes a third recording film 52R and further includes a dielectric film 52D for protecting the third recording film 52R on both sides thereof. Note that the third information layer 52 does not have any light absorbing films. However, the second information layer 14 includes the second recording film 14R and also a light absorbing film 14A.

Since other components are the same as those of the optical recording medium 10, the same reference numerals as in FIGS. 1 and 2 are used, and a redundant description is omitted.

The same material used to form the first and second recording films 12R and 14R may be used as the material forming the third recording film 52R. In an optical recording medium having three or more information layers as in the fourth exemplary embodiment, it is particularly important for each of the information layers to have a high transmittance, and the extinction coefficient of the recording film of the each of the information layers is preferably 0.2 or less. Preferably, a material which consists essentially of Bi, O, and M (M is at least one element selected from the group consisting of Mg, Ca, Ti, Zr, Nb, Zn, Al, Si, Ge, Sn, Sb, Na, and K) and in which the ratio of the number of O atoms to the total number of all the atoms constituting the material is 62% or more may be used as the material forming the recording film. In this case, a recording film having a small extinction coefficient and a high transmittance can be provided, which is suitable for the recording film for an optical recording medium having three or more information layers. Preferably, the thickness of the third recording film 52R is substantially the same as the thicknesses of the first and second recording films 12R and 14R.

The same material used to form the light absorbing film 12A of the first information layer 12 may be used as the material forming the light absorbing film 14A of the second information layer 14. Preferably, the light absorbing film 14A of the second information layer 14 is thinner than the light absorbing film 12A of the first information layer 12.

As in the optical recording medium 10 of the two-layer recording type, in the optical recording medium 50 of the three-layer recording type, a common material is used as the materials forming the first recording film 12R of the first information layer 12, the second recording film 14R of the second information layer 14, and the third recording film 52R of the third information layer 52. Therefore, through the use of common materials, the effect of reducing manufacturing costs is expected. In addition to this, each of the first to third recording films 12R, 14R, and 52R has a small extinction coefficient of, for example, 0.2 or less at the wavelength of the laser beam used for recording and reproducing. Therefore, even when the thicknesses of the second and third recording films 14R and 52R are substantially the same as the thickness of the first recording film 12R, the amount of absorption of the laser beam in each of the second and third information layers 14 and 52 is small, so that the effect of increasing the amount of the laser beam reaching each of the first and second information layers 12 and 14 can be obtained.

Moreover, in the optical recording medium 50, the first information layer 12 includes the light absorbing film 12A having an extinction coefficient that is greater than that of the first recording film 12R, and also the second information layer 14 includes the light absorbing film 14A having an extinction coefficient that is greater than that of the second recording film 14R. Therefore, even when the extinction coefficients of the first and second recording films 12R and 14R are small, the light absorbing films 12A and 14A absorb the laser beam, so that the irradiated area in each of the first and second information layers 12 and 14 is heated sufficiently. Accordingly, recording marks as good as those formed in the third information layer 52 can be formed in the first and second information layers 12 and 14.

Furthermore, each of the second and third recording films 14R and 52R has a small extinction coefficient of, for example, 0.2 or less at the wavelength of the laser beam used for recording and reproducing. Hence, the light reflected from the first and second information layers 12 and 14 is less absorbed by the second information layer 14 and the third information layer 52, respectively, so that the effect of increasing the amount of light reaching the photodetector 24 can be obtained. Accordingly, when the output power levels of the reproducing laser beams projected onto the first to third information layers 12, 14, and 52 are the same, the light beams reflected from the three information layers can be detected by the photodetector 24 such that the detected reflectivity values are close to each other.

A description will be given of a fifth exemplary embodiment of the present invention.

The optical recording medium 50 according to the fourth exemplary embodiment is of the three-layer recording type that includes the first to third information layers 12, 14, and 52. However, as shown in FIG. 6, an optical recording medium 60 according to the fifth exemplary embodiment is characterized in that the medium is of a four-layer recording type that further includes a fourth information layer 62 in addition to the first to third information layers 12, 14, and 52. The fourth information layer 62 is disposed between the third information layer 52 and the cover layer 20.

The fourth information layer 62 includes a fourth recording film 62R and further includes a dielectric film 62D for protecting the fourth recording film 62R on both sides thereof. Note that the fourth information layer 62 does not have any light absorbing film. However, the third information layer 52 includes the third recording film 52R and also a light absorbing film 52A.

Since other components are the same as those of the optical recording medium 50, the same reference numerals as in FIG. 5 are used, and a redundant description is omitted.

The same material used to form the first to third recording films 12R, 14R, and 52R may be used as the material forming the fourth recording film 62R. Preferably, as in the first to third recording films 12R, 14R, and 52R in the fourth exemplary embodiment, the fourth recording film 62R has an extinction coefficient of 0.2 or less at the wavelength of the laser beam used for recording and reproducing. Preferably, the thickness of the fourth recording film 62R is substantially the same as the thicknesses of the first to third recording films 12R, 14R, and 52R.

The same material used to form the light absorbing film 12A of the first information layer 12 and the light absorbing film 14A of the second information layer 14 may be uses as the material forming the light absorbing film 52A of the third information layer 52. Preferably, the light absorbing film 52A of the third information layer 52 is thinner than the light absorbing film 12A of the first information layer 12 and the light absorbing film 14A of the second information layer 14.

As in the optical recording medium 50 of the three-layer recording type, in the optical recording medium 60 of the four-layer recording type, a common material having a small extinction coefficient of, for example, 0.2 or less at the wavelength of the laser beam used for recording and reproducing is used as the materials forming the first recording film 12R of the first information layer 12, the second recording film 14R of the second information layer 14, the third recording film 52R of the third information layer 52, and the fourth recording film 62R of the fourth information layer 62. Therefore, through the use of common materials, the effect of reducing manufacturing costs is expected. In addition to this, even when the thicknesses of the fourth recording film 62R of the fourth information layer 62, the third recording film 52R of the third information layer 52, the second recording film 14R of the second information layer 14, and the first recording film 12R of the first information layer 12 are substantially the same, the amount of absorption of the laser beam in each of the second to fourth information layers 14, 52, and 62 is small, so that the effect of increasing the amount of the laser beam reaching each of the first to third information layers 12, 14, and 52 can be obtained.

Moreover, in the optical recording medium 60, the first information layer 12 includes the light absorbing film 12A having an extinction coefficient that is greater than that of the first recording film 12R, and also the second information layer 14 includes the light absorbing film 14A having an extinction coefficient that is greater than that of the second recording film 14R. In addition, the third information layer 52 includes the light absorbing film 52A having an extinction coefficient that is greater than that of the third recording film 52R. Therefore, even when the extinction coefficients of the first to third recording films 12R, 14R, and 52R are small, the light absorbing films 12A, 14A, and 52A absorb the laser beam, so that the irradiated area in each of the first to third information layers 12, 14, and 52 is heated sufficiently. Accordingly, recording marks as good as those formed in the fourth information layer 62 can be formed in the first to third information layers 12, 14, and 52.

Furthermore, each of the second to fourth recording films 14R, 52R, and 62R has a small extinction coefficient of, for example, 0.2 or less at the wavelength of the laser beam used for recording and reproducing. Hence, the light reflected from the first to third information layers 12, 14, and 52 is less absorbed by the second information layer 14, the third information layer 52 and the fourth information layer 62, respectively, so that the effect of increasing the amount of light reaching the photodetector 24 can be obtained. Accordingly, when the output power levels of the reproducing laser beams projected onto the first to fourth information layers 12, 14, 52, and 62 are the same, the light beams reflected from the four information layers can be detected by the photodetector 24 such that the detected reflectivity values are close to each other.

A description will now be given of a sixth exemplary embodiment of the present invention.

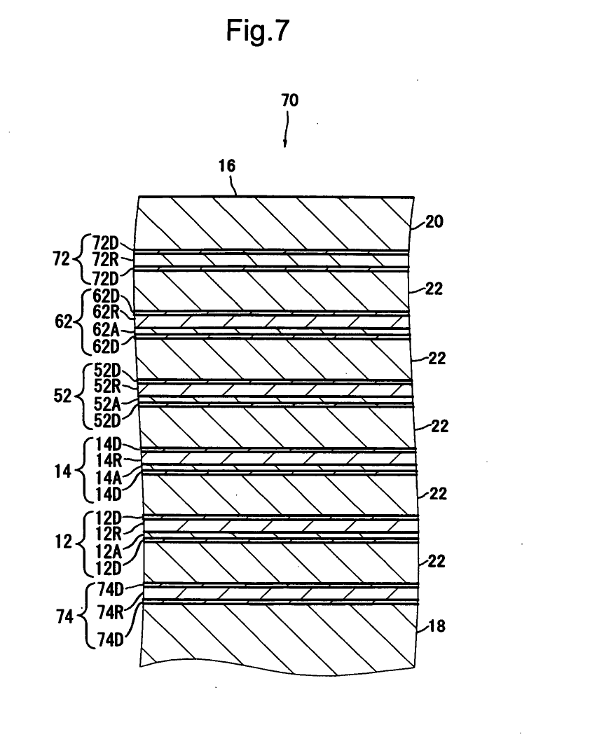

As described above, the optical recording medium 60 according to the fifth exemplary embodiment is the four-layer recording type and includes the first to fourth information layers 12, 14, 52, and 62. However, as shown in FIG. 7, an optical recording medium 70 according to the sixth exemplary embodiment is characterized in that the medium is of a six-layer recording type which further includes a fifth information layer 72 and a bottom information layer 74 in addition to the first to fourth information layers 12, 14, 52, and 62. The fifth information layer 72 is disposed between the fourth information layer 62 and the cover layer 20. The bottom information layer 74 is disposed between the first information layer 12 and the substrate 18.

The fifth information layer 72 includes a fifth recording film 72R and further includes a dielectric film 72D for protecting the fifth recording film 72R on both sides thereof. Note that the fifth information layer 72 does not have any light absorbing film. However, the fourth information layer 62 includes the fourth recording film 62R and also a light absorbing film 62A.

The bottom information layer 74 includes a bottom recording film 74R and a dielectric film 74D which is provided on both sides of the bottom recording film 74R. Note that the bottom information layer 74 does not have any light absorbing film.

Since other components are the same as those of the optical recording medium 60, the same reference numerals as in FIG. 6 are used, and a redundant description is omitted.

The same material used to form the first to fourth recording films 12R, 14R, 52R, and 62R may be used as the material forming the fifth recording film 72R and the bottom recording film 74R. Preferably, also in the sixth exemplary embodiment, each of the first to fifth recording films 12R, 14R, 52R, 62R, and 72R has an extinction coefficient of 0.2 or less at the wavelength of the laser beam used for recording and reproducing. In an optical recording medium having five or more information layers, for example, six information layers as in the sixth exemplary embodiment, it is particularly important for each of the information layers to have a high transmittance, and the extinction coefficient of the recording film of the each of the information layer is more preferably 0.1 or less. Note that a material different from the material used to form the first to fifth recording films 12R, 14R, 52R, 62R and 72R may be used as the material forming the bottom recording film 74R. For example, a laminate of Si and Cu may be used. The extinction coefficient of the bottom recording film 74R may be greater than those of the first to fifth recording films 12R, 14R, 52R, 62R and 72R. Preferably, the thickness of the fifth recording film 72R is substantially the same as the thicknesses of the first to fourth recording films 12R, 14R, 52R, and 62R.

The same material used to form the light absorbing film 12A of the first information layer 12, the light absorbing film 14A of the second information layer 14, and the light absorbing film 52A of the third information layer 52 may be used as the material forming the light absorbing film 62A of the fourth information layer 62. Preferably, the light absorbing film 62A of the fourth information layer 62 is thinner than the light absorbing film 12A of the first information layer 12, the light absorbing film 14A of the second information layer 14, and the light absorbing film 52A of the third information layer 52.

As in the optical recording medium 60 of the four-layer recording type, in the optical recording medium 70 of the six-layer recording type, a common material is used as the materials forming the first recording film 12R of the first information layer 12, the second recording film 14R of the second information layer 14, the third recording film 52R of the third information layer 52, the fourth recording film 62R of the fourth information layer 62, and the fifth recording film 72R of the fifth information layer 72. Therefore, through the use of common materials, the effect of reducing manufacturing costs is expected. In addition to this, each of the first to fifth recording films 12R, 14R, 52R, 62R, and 72R has a small extinction coefficient of, for example, 0.1 or less. Therefore, even when the first to fifth recording films 12R, 14R, 52R, 62R, and 72R have substantially the same thickness, the amount of absorption of the laser beam in each of the first to fifth information layers 12, 14, 52, 62, and 72 is small, so that the effect of increasing the amount of the laser beam reaching each of the bottom information layer 74 and the first to fourth information layers 12, 14, 52, and 62 can be obtained.

Moreover, in the optical recording medium 70, the first information layer 12 includes the light absorbing film 12A having an extinction coefficient that is greater than that of the first recording film 12R, and also the second information layer 14 includes the light absorbing film 14A having an extinction coefficient that is greater than that of the second recording film 14R. In addition, the third information layer 52 includes the light absorbing film 52A having an extinction coefficient that is greater than that of the third recording film 52R, and also the fourth information layer 62 includes the light absorbing film 62A having an extinction coefficient that is greater than that of the fourth recording film 62R. Therefore, even when the extinction coefficients of the first to fourth recording films 12R, 14R, 52R, and 62R are small, the light absorbing films 12A, 14A, 52A and 62A absorb the laser beam, so that the irradiated area in each of the first to fourth information layers 12, 14, 52, and 62 is heated sufficiently. Accordingly, recording marks as good as those formed in the fifth information layer 72 can be formed in the first to fourth information layers 12, 14, 52, and 62.

Furthermore, each of the first to fifth recording films 12R, 14R, 52R, 62R, and 72R has a small extinction coefficient of, for example, 0.1 or less. Hence, the light reflected from the bottom information layer 74, the first to fourth information layers 12′, 14, 52, and 62 is less absorbed by the first to fifth information layers 12, 14, 52, 62 and 72, respectively, so that the effect of increasing the amount of light reaching the photodetector 24 can be obtained. Accordingly, when the output power levels of the reproducing laser beams projected onto the bottom information layer 74 and the first to fifth information layers 12, 14, 52, 62, and 72 are the same, the light beams reflected from the six information layers can be detected by the photodetector 24 such that the detected reflectivity values are close to each other.

In the first to sixth exemplary embodiments, the materials that consist essentially of Bi, O, and M and the materials that consist essentially of Bi and O are exemplified as the materials forming the first to fifth recording films 12R, 14R, 52R, 62R, and 72R. However, any material may be used as the materials forming the first to fifth recording films 12R, 14R, 52R, 62R, and 72R, so long as it has a sufficiently small extinction coefficient (being of 0.4 or less).

Moreover, in each of the fourth and fifth exemplary embodiments, the same material used as the material forming the second and third recording films 14R and 52R is exemplified as the material forming the first recording film 12R. However, since other information layers are not present between the first information layer 12 and the substrate 18, any material having an extinction coefficient that is greater than that of the second and third recording films 14R and 52R may be used as the material forming the first recording film 12R.

Furthermore, in the configuration of each of the first to sixth exemplary embodiments, the first information layer 12 or the bottom information layer 74 comes into direct contact with the substrate 18. However, a reflective layer may be provided between the substrate 18 and the first information layer 12 or the bottom information layer 74. As the material forming the reflective layer, Al, Ag, Au, Cu, Mg, Ti, Cr, Fe, Co, Ni, Zn, Ge, Pt, or Pd or an alloy thereof may be used. Of these, Al, Ag, Au, Cu, or an alloy such as AgPdCu is preferably used since a high reflectivity can be obtained. In addition, a dielectric material can be used as the material forming the reflective layer.

Moreover, in the first to sixth exemplary embodiments, the first to fifth information layers 12, 14, 52, 62, and 72 and the bottom information layer 74 each have the two dielectric films 12D, 14D, 52D, 62D, 72D, or 74D. However, one or both of the dielectric films may be omitted.

Furthermore, in the first to sixth exemplary embodiments, examples of the optical recording media of the two-, three-, four-, and six-layer types are shown. However, the present invention is suitably applicable to optical recording media of, for example, five-, seven-, and eight-layer recording types and for optical recording media having nine or more recording films.

Moreover, in each of the first to sixth exemplary embodiments, an example of the single-sided optical recording medium having the recording film on one side is shown. However, various exemplary embodiments of the present invention are of course applicable to a double-sided optical recording medium having the recording film on both sides.

Furthermore, in the first to sixth exemplary embodiments, each of the optical recording media 10, 30, 40, 50, 60, and 70 has the structure of a Blu-ray Disc in which the cover layer 20 is thinner than the substrate 18. However, various exemplary embodiments of the present invention are of course applicable to an optical recording medium in which the thickness of a substrate is the same as that of a cover layer as in an HD DVD. In such a case, the shape of the substrate is substantially the same as the shape of the cover layer. However, in the present application, a layer irradiated with the laser beam for recording and reproducing is referred to as the cover layer.

### Working Example 1

Five samples A to E of a two-layer recording type optical recording medium were produced, each of which had the same configuration as that of the optical recording medium 10 of the first exemplary embodiment or the optical recording medium 30 of the second exemplary embodiment. The configuration of the first information layer 12 and the configuration of the second information layer 14 of each of the samples A to E are shown in Table 1. In Table 1, the films constituting each information layer are arranged in order from left to right. This order means that these films are disposed in this order from the substrate side to the cover layer side. This is also the case in each of Tables 2 to 7 described later.

TABLE 1

| | | | | | Light | | | | | |
|---|---|---|---|---|---|---|---|---|---|---|
| | | Dielectric film | | | absorbing film | | | Recording film | | |
| | | | Extinction | Thickness | | Extinction | Thickness | | Extinction | Thickness |
| Sample | | Material | coefficien | (nm) | Material | coefficient | (nm) | Material | coefficient | (nm) |
| A | First information layer | TiO₂ | 0.05 | 5 | Fe₂O₃ | 0.8 | 8 | Bi:Fe:O = 20:12:68 | 0.38 | 40 |
| | Second information layer | TiO₂ | 0.05 | 14.5 | — | — | — | Bi:Fe:O = 20:12:68 | 0.38 | 40 |
| B | First information layer | TiO₂ | 0.05 | 5 | V₂O₅ | 0.5 | 8 | Bi:Fe:O = 20:12:68 | 0.38 | 40 |
| | Second information layer | TiO₂ | 0.05 | 14.5 | — | — | — | Bi:Fe:O = 20:12:68 | 0.38 | 40 |
| C | First information layer | TiO₂ | 0.05 | 13 | — | — | — | Bi:Ge:O = 23:9:68 | 0.1 | 40 |
| | Second information layer | TiO₂ | 0.05 | 14 | — | — | — | Bi:Ge:O = 23:9:68 | 0.1 | 40 |
| D | First information layer | TiO₂ | 0.05 | 11 | Fe₂O₃ | 0.8 | 1.5 | Bi:Ge:O = 23:9:68 | 0.1 | 40 |
| | Second information layer | TiO₂ | 0.05 | 14 | — | — | — | Bi:Ge:O = 23:9:68 | 0.1 | 40 |
| E | First information layer | TiO₂ | 0.05 | 5 | Fe₂O₃ | 0.8 | 7 | Bi:Ge:O = 23:9:68 | 0.1 | 40 |
| | Second information layer | TiO₂ | 0.05 | 10 | Fe₂O₃ | 0.8 | 4 | Bi:Ge:O = 23:9:68 | 0.1 | 40 |

| | | Light absorbing film | | | Dielectric film | | | | Optimal | |
|---|---|---|---|---|---|---|---|---|---|---|
| | | | Extinction | Thickness | | Extinction | Thickness | Reflectivity | recording | Jitter |
| Sample | | Material | coefficien | (nm) | Material | coefficient | (nm) | (%) | power (mW) | (%) |
| A | First information layer | — | — | — | TiO₂ | 0.05 | 5 | 3.0 | 3.5 | 6.3 |
| | Second information layer | — | — | — | TiO₂ | 0.05 | 15 | 3.2 | 3.0 | 5.8 |
| B | First information layer | — | — | — | TiO₂ | 0.05 | 5 | 3.6 | 3.8 | 6.5 |
| | Second information layer | — | — | — | TiO₂ | 0.05 | 15 | 3.2 | 3.2 | 5.9 |
| C | First information layer | Fe₂O₃ | 0.8 | 2 | TiO₂ | 0.05 | 13 | 3.1 | 7.9 | 5.6 |
| | Second information layer | — | — | — | TiO₂ | 0.05 | 14 | 3.5 | 8.8 | 6.0 |
| D | First information layer | — | — | — | TiO₂ | 0.05 | 12 | 3.4 | 7.8 | 5.7 |
| | Second information layer | — | — | — | TiO₂ | 0.05 | 14 | 3.5 | 8.8 | 5.8 |
| E | First information layer | — | — | — | TiO₂ | 0.05 | 5 | 3.2 | 4.8 | 5.6 |
| | Second information layer | — | — | — | TiO₂ | 0.05 | 11 | 3.4 | 4.8 | 5.3 |

In each of the samples A to E, the thickness of the substrate 18 was 1.1 mm, the thickness of the cover layer 20 was 75 μm, and the thickness of the spacer layer 22 was 25 μm.

Each of the five samples A to E was measured for the reflectivity (of an unrecorded portion), optimal recording power, and jitter of each of the first and second information layers 12 and 14. The results are also shown in Table 1. The reflectivities of the first and second information layers 12 and 14 were measured using a reproducing laser beam having a wavelength of 405 nm and a constant output power level. The reflectivities shown in Table 1 are ones detected by the photodetector 24. The optimal recording power was measured using the following method. First, a laser beam having a wavelength of 405 nm was projected onto each of the samples at various powers to form recording marks in each of the information layers. Next, the jitter value of each of the recording marks was measured by means of a recording and reproducing apparatus. Since the output power level of the laser beam used for forming a recording mark having the lowest jitter value is suitable for the output power level of the laser beam for the corresponding sample, this output power level was used as the optimal recording power. In this instance, the output power level of the laser beam was determined by converting the intensity of the laser beam on the incident surface 16 to an electrical power.

The extinction coefficients of the first and second recording films 12R and 14R of each of the samples A to E were measured as follows. First, a film having a composition the same as that of each of the first and second recording films 12R and 14R of each of the samples A to E was deposited to a thickness of 70 nm on a flat polycarbonate substrate having no grooves formed thereon. Next, the extinction coefficient of each of the films at a wavelength of 405 nm was determined by means of ETA-RT (product of STEAG ETA-Optik).

### Working Example 2

One sample F of a two-layer recording type optical recording medium was produced. Sample F was different from the sample D of Working Example 1 in that a different material was used as the material forming the light absorbing film 12A and that a dielectric film was disposed between the light absorbing film 12A and the first recording film 12R. The configuration of the first information layer 12 and the configuration of the second information layer 14 of the sample F are shown in Table 2.

TABLE 2

| | | | | | Light | | | | | |
|---|---|---|---|---|---|---|---|---|---|---|
| | | Dielectric film | | | absorbing film | | | Recording film | | |
| | | | Extinction | Thickness | | Extinction | Thickness | | Extinction | Thickness |
| Sample | | Material | coefficient | (nm) | Material | coefficien | (nm) | Material | coefficient | (nm) |
| F | First information layer | TiO₂ | 0.05 | 5 | Al₇₂Cr₉O₁₉ | 1.4 | 3 | TiO₂ | 0.05 | 5 |
| | Second information | TiO₂ | 0.05 | 14 | — | — | — | — | — | — |
| | layer | | | | | | | | | |

| | | Light absorbing film | | | Dielectric film | | | | Optimal | |
|---|---|---|---|---|---|---|---|---|---|---|
| | | | Extinction | Thickness | | Extinction | Thickness | Reflectivity | recording | Jitter |
| Sample | | Material | coefficient | (nm) | Material | coefficient | (nm) | (%) | power (mW) | (%) |
| F | First | Bi:Fe:O = 23:9:68 | 0.1 | 40 | TiO₂ | 0.05 | 10 | 3.3 | 4.1 | 6.2 |
| | information | | | | | | | | | |
| | layer | | | | | | | | | |
| | Second | Bi:Fe:O = 23:9:68 | 0.1 | 40 | TiO₂ | 0.05 | 14 | 3.2 | 3.7 | 5.9 |
| | information | | | | | | | | | |
| | layer | | | | | | | | | |

The other components of the sample F were the same as those of the sample D.

As in Working Example 1, the sample F was measured for the reflectivity (of an unrecorded portion), optimal recording power, and jitter of each of the first and second information layers 12 and 14. Moreover, as in Working Example 1, the extinction coefficients of the first and second recording films 12R and 14R were measured. The measurement results are also shown in Table 2.

### Working Example 3

Sample G of a three-layer recording type optical recording medium was produced, which had the same configuration as that of the optical recording medium 50 of the fourth exemplary embodiment. The configuration of each of the first to third information layers 12, 14, and 52 of the sample G is shown in Table 3.

TABLE 3

| | | | | | Light | | | | | |
|---|---|---|---|---|---|---|---|---|---|---|
| | | Dielectric film | | | absorbing film | | | Recording film | | |
| | | | Extinction | Thickness | | Extinction | Thickness | | Extinction | Thickness |
| Sample | | Material | coefficient | (nm) | Material | coefficient | (nm) | Material | coefficient | (nm) |
| G | First information layer | TiO₂ | 0.05 | 3 | Fe₂O₃ | 0.8 | 5 | Bi:Ge:O = 28:2:70 | 0.18 | 40 |
| | Second information layer | TiO₂ | 0.05 | 10 | Fe₂O₃ | 0.8 | 2.5 | Bi:Ge:O = 28:2:70 | 0.18 | 40 |
| | Third information layer | TiO₂ | 0.05 | 15 | — | — | — | Bi:Ge:O = 28:2:70 | 0.18 | 40 |

| | | Light absorbing film | | | Dielectric film | | | | Optimal | |
|---|---|---|---|---|---|---|---|---|---|---|
| | | | Extinction | Thickness | | Extinction | Thickness | Reflectivity | recording | Jitter |
| Sample | | Material | coefficient | (nm) | Material | coefficient | (nm) | (%) | power (mW) | (%) |
| G | First information layer | Fe₂O₃ | 0.8 | 5 | TiO₂ | 0.05 | 4 | 3.1 | 5.4 | 6.3 |
| | Second information layer | — | — | — | TiO₂ | 0.05 | 10 | 3.5 | 5.3 | 6.2 |
| | Third information layer | — | — | — | TiO₂ | 0.05 | 15 | 2.9 | 4.8 | 5.8 |

In the sample G, the thickness of the substrate 18 was 1.1 mm, the thickness of the cover layer 20 was 63 μm, the thickness of the spacer layer 22 between the first and second information layers 12 and 14 was 17 μm, and the thickness of the spacer layer 22 between the second and third information layers 14 and 52 was 20 μm.

As in Working Example 1, the sample G was measured for the reflectivity (of an unrecorded portion), optimal recording power, and jitter of each of the first to third information layers 12, 14, and 52. Moreover, as in Working Example 1, the extinction coefficients of the first to third recording films 12R, 14R, and 52R were measured. The measurement results are also shown in Table 3.

### Working Example 4

Sample H of a four-layer recording type optical recording medium was produced, which had the same configuration as that of the optical recording medium 60 of the fifth exemplary embodiment. Table 4 shows the configuration of each of the first to fourth information layers 12, 14, 52, and 62 of the sample H.

TABLE 4

| | | | | | Light | | | | | |
|---|---|---|---|---|---|---|---|---|---|---|
| | | Dielectric film | | | absorbing film | | | Recording film | | |
| | | | Extinction | Thickness | | Extinction | Thickness | | Extinction | Thickness |
| Sample | | Material | coefficient | (nm) | Material | coefficient | (nm) | Material | coefficient | (nm) |
| H | First information layer | TiO₂ | 0.05 | 7 | Fe₂O₃ | 0.8 | 3 | Bi:Ge:O = 28:2:70 | 0.18 | 33 |
| | Second information layer | TiO₂ | 0.05 | 13 | Fe₂O₃ | 0.8 | 2 | Bi:Ge:O = 28:2:70 | 0.18 | 33 |
| | Third information layer | TiO₂ | 0.05 | 16.5 | Fe₂O₃ | 0.8 | 0.5 | Bi:Ge:O = 28:2:70 | 0.18 | 33 |
| | Fourth information layer | TiO₂ | 0.05 | 18 | — | — | — | Bi:Ge:O = 28:2:70 | 0.18 | 33 |

| | | Light absorbing film | | | Dielectric film | | | | Optimal | |
|---|---|---|---|---|---|---|---|---|---|---|
| | | | Extinction | Thickness | | Extinction | Thickness | Reflectivity | recording | Jitter |
| Sample | | Material | coefficient | (nm) | Material | coefficient | (nm) | (%) | power (mW) | (%) |
| H | First information layer | Fe₂O₃ | 0.8 | 3 | TiO₂ | 0.05 | 7 | 2.5 | 8.4 | 7.1 |
| | Second information layer | — | — | — | TiO₂ | 0.05 | 13.5 | 2.6 | 7.8 | 6.5 |
| | Third information layer | — | — | — | TiO₂ | 0.05 | 17 | 2.7 | 6.3 | 6.2 |
| | Fourth information layer | — | — | — | TiO₂ | 0.05 | 18.5 | 2.9 | 6.7 | 5.8 |

In the sample H, the thickness of the substrate 18 was 1.1 mm, the thickness of the cover layer 20 was 50 μm, the thickness of the spacer layer 22 between the first and second information layers 12 and 14 was 17 μm, the thickness of the spacer layer 22 between the second and third information layers 14 and 52 was 20 μm, and the thickness of the spacer layer 22 between the third and fourth information layers 52 and 62 was 13 μm.

As in Working Example 1, the sample H was measured for the reflectivity (of an unrecorded portion), optimal recording power, and jitter of each of the first to fourth information layers 12, 14, 52, and 62. Moreover, as in Working Example 1, the extinction coefficients of the first to fourth recording films 12R, 14R, 52R, and 62R were measured. The measurement results are also shown in Table 4.

### Working Example 5

Sample J of a six-layer recording type optical recording medium was produced, which had the same configuration as that of the optical recording medium 70 of the sixth exemplary embodiment. Table 5 shows the configuration of each of the bottom information layer 74 and the first to fifth information layers 12, 14, 52, 62, and 72 of the sample J.

TABLE 5

| | | | | | Light | | | | | |
|---|---|---|---|---|---|---|---|---|---|---|
| | | Dielectric film | | | absorbing film | | | Recording film | | |
| | | | Extinction | Thickness | | Extinction | Thickness | | Extinction | Thickness |
| Sample | | Material | coefficient | (nm) | Material | coefficient | (nm) | Material | coefficient | (nm) |
| J | Bottom information layer | ZnS/ | — | 40 | — | — | — | Cu | — | 6 |
| | | SiO₂ | | | | | | Si | — | 6 |
| | First information layer | TiO₂ | 0.05 | 8 | Fe₂O₃ | 0.8 | 2 | Bi:Ge:O = 23:9:68 | 0.1 | 35 |
| | Second information layer | TiO₂ | 0.05 | 11.5 | Fe₂O₃ | 0.8 | 2 | Bi:Ge:O = 23:9:68 | 0.1 | 35 |
| | Third information layer | TiO₂ | 0.05 | 14.5 | Fe₂O₃ | 0.8 | 1 | Bi:Ge:O = 23:9:68 | 0.1 | 35 |
| | Fourth information layer | TiO₂ | 0.05 | 16 | Fe₂O₃ | 0.8 | 0.5 | Bi:Ge:O = 23:9:68 | 0.1 | 35 |
| | Fifth information layer | TiO₂ | 0.05 | 17 | — | — | — | Bi:Ge:O = 23:9:68 | 0.1 | 35 |

| | | Light absorbing film | | | Dielectric film | | | | Optimal | |
|---|---|---|---|---|---|---|---|---|---|---|
| | | | Extinction | Thickness | | Extinction | Thickness | Reflectivity | recording | Jitter |
| Sample | | Material | coefficient | (nm) | Material | coefficient | (nm) | (%) | power (mW) | (%) |
| J | Bottom information layer | — | — | — | ZnS/ | — | 40 | 2.5 | 11.5 | 7.3 |
| | | | | | SiO₂ | | | | | |
| | First information layer | Fe₂O₃ | 0.8 | 2 | TiO₂ | 0.05 | 8 | 2.3 | 11.5 | 7.8 |
| | Second information layer | — | — | — | TiO₂ | 0.05 | 11.5 | 2.6 | 12 | 5.9 |
| | Third information layer | — | — | — | TiO₂ | 0.05 | 14.5 | 2.5 | 11 | 6.2 |
| | Fourth information layer | — | — | — | TiO₂ | 0.05 | 16.5 | 2.2 | 10.2 | 5.7 |
| | Fifth information layer | — | — | — | TiO₂ | 0.05 | 17.5 | 2.6 | 9.8 | 5.8 |

The recording film of the bottom information layer 74 was a laminate formed of a Cu layer on the substrate 18 side and an Si layer on the cover layer 20 side, which is different from the materials forming the other recording films. Moreover, a reflective layer which was formed of AgPdCu and had a thickness of 100 nm was disposed between the bottom information layer 74 and the substrate 18.

In the sample J, the thickness of the substrate 18 was 1.1 mm, and the thickness of the cover layer 20 was 40 μm. The thickness of the spacer layer 22 between the bottom information layer 74 and the first information layer 12 was 17 μm, and the thickness of the spacer layer 22 between the first and second information layers 12 and 14 was 20 μm. The thickness of the spacer layer 22 between the second and third information layers 14 and 52 was 13 μm, and the thickness of the spacer layer 22 between the third and fourth information layers 52 and 62 was 15 μm. Furthermore, the thickness of the spacer layer 22 between the fourth and fifth information layers 62 and 72 was 10 μm.

As in Working Example 1, the sample J was measured for the reflectivity (of an unrecorded portion), optimal recording power, and jitter of each of the bottom information layer 74 and the first to fifth information layers 12, 14, 52, 62, and 72. Moreover, as in Working Example 1, the extinction coefficients of the first to fifth recording films 12R, 14R, 52R, 62R, and 72R were measured. The measurement results are also shown in Table 5.

### Comparative Example 1

Two samples K and L of a two-layer recording type optical recording medium were produced which were different from Working Example 1 in that the light absorbing film 12A was omitted. Moreover, sample M of a two-layer recording type optical recording medium was produced which was different from Working Example 1 in that the composition of the material forming the light absorbing film 12A was changed. In addition, sample N of a two-layer recording type optical recording medium was produced which was different from Working Example 1 in that the materials forming the first and second recording films 12R and 14R were changed. The configuration of each of the first and second information layers 12 and 14 of each of the samples K to N is shown in Table 6.

TABLE 6

| | | | | | Light | | | | | |
|---|---|---|---|---|---|---|---|---|---|---|
| | | Dielectric film | | | absorbing film | | | Recording film | | |
| | | | Extinction | Thickness | | Extinction | Thickness | | Extinction | Thickness |
| Sample | | Material | coefficient | (nm) | Material | coefficient | (nm) | Material | coefficient | (nm) |
| K | First information layer | TiO₂ | 0.05 | 5 | — | — | — | Bi:Fe:O = 20:12:68 | 0.38 | 52 |
| | Second information layer | TiO₂ | 0.05 | 14 | — | — | — | Bi:Fe:O = 20:12:68 | 0.38 | 40 |
| L | First information layer | TiO₂ | 0.05 | 50 | — | — | — | Bi:Fe:O = 20:12:68 | 0.38 | 52 |
| | Second information layer | TiO₂ | 0.05 | 14 | — | — | — | Bi:Fe:O = 20:12:68 | 0.38 | 40 |
| M | First information layer | TiO₂ | 0.05 | 5 | Ag | 4.0 | 8 | Bi:Fe:O = 20:12:68 | 0.38 | 40 |
| | Second information layer | TiO₂ | 0.05 | 14.5 | — | — | — | Bi:Fe:O = 20:12:68 | 0.38 | 40 |
| N | First information layer | TiO₂ | 0.05 | 5 | Fe₂O₃ | 0.8 | 4 | Bi:Fe:O = 16:17:67 | 0.57 | 40 |
| | Second information layer | TiO₂ | 0.05 | 14 | — | — | — | Bi:Fe:O = 16:17:67 | 0.57 | 40 |

| | | Light absorbing film | | | Dielectric film | | | | Optimal | |
|---|---|---|---|---|---|---|---|---|---|---|
| | | | Extinction | Thickness | | Extinction | Thickness | Reflectivity | recording | Jitter |
| Sample | | Material | coefficient | (nm) | Material | coefficient | (nm) | (%) | power (mW) | (%) |
| K | First information layer | — | — | — | TiO₂ | 0.05 | 5 | 2.2 | 4.2 | 6.2 |
| | Second information layer | — | — | — | TiO₂ | 0.05 | 14 | 3.2 | 3.0 | 6.0 |
| L | First information layer | — | — | — | TiO₂ | 0.05 | 50 | 3.1 | 3.2 | 12.2 |
| | Second information layer | — | — | — | TiO₂ | 0.05 | 14 | 3.2 | 3.0 | 6.1 |
| M | First information layer | — | — | — | TiO₂ | 0.05 | 5 | 2.7 | 3.2 | 12.9 |
| | Second information layer | — | — | — | TiO₂ | 0.05 | 15 | 3.2 | 3.0 | 6.0 |
| N | First information layer | — | — | — | TiO₂ | 0.05 | 5 | 2.8 | 4.1 | 6.4 |
| | Second information layer | — | — | — | TiO₂ | 0.05 | 14 | 3.9 | 2.0 | 7.5 |

The thickness of the dielectric film of the first information layer of the sample L was significantly larger than the thickness of the dielectric film of the first information layer of the sample K. This was intended to increase the amount of light absorption while a sufficient reflectivity was maintained. Specifically, the thickness was increased by an amount corresponding to (½)×(λ/n) where n is the (average) refractive index of the first information layer and λ is the wavelength (in vacuum) of the irradiation beam. The components other than the information layers of each of the samples K to N were the same as those of Working Example 1.

As in Working Example 1, each of the samples K to N was measured for the reflectivity (of an unrecorded portion), optimal recording power, and jitter of each of the first and second information layers 12 and 14. Moreover, as in Working Example 1, the extinction coefficients of the first and second recording films 12R and 14R were measured. The measurement results are also shown in Table 6.

### Comparative Example 2

Sample P of a three-layer recording type optical recording medium was produced which was different from Working Example 3 in that the light absorbing film 12A was omitted. In addition, sample Q of a three-layer recording type optical recording medium was produced which was different from Working Example 3 in that the materials of the first to third recording films 12R, 14R, and 52R were changed. The configuration of each of the first to third information layers 12, 14, and 52 of the samples P and Q is shown in Table 7.

TABLE 7

| | | | | | Light | | | | | |
|---|---|---|---|---|---|---|---|---|---|---|
| | | Dielectric film | | | absorbing film | | | Recording film | | |
| | | | Extinction | Thickness | | Extinction | Thickness | | Extinction | Thickness |
| Sample | | Material | coefficient | (nm) | Material | coefficient | (nm) | Material | coefficient | (nm) |
| P | First information layer | TiO₂ | 0.05 | 5 | — | — | — | Bi:Ge:O = 28:2:70 | 0.18 | 54 |
| | Second information layer | TiO₂ | 0.05 | 9 | — | — | — | Bi:Ge:O = 28:2:70 | 0.18 | 60 |
| | Third information layer | TiO₂ | 0.05 | 15 | — | — | — | Bi:Ge:O = 28:2:70 | 0.18 | 40 |
| Q | First information layer | TiO₂ | 0.05 | 3 | Fe₂O₃ | 0.8 | 5 | Bi:Fe:O = 20:12:68 | 0.38 | 40 |
| | Second information layer | TiO₂ | 0.05 | 5 | Fe₂O₃ | 0.8 | 5 | Bi:Fe:O = 20:12:68 | 0.38 | 40 |
| | Third information layer | TiO₂ | 0.05 | 14 | — | — | — | Bi:Fe:O = 20:12:68 | 0.38 | 40 |

| | | Light absorbing film | | | Dielectric film | | | | Optimal | |
|---|---|---|---|---|---|---|---|---|---|---|
| | | | Extinction | Thickness | | Extinction | Thickness | Reflectivity | recording | Jitter |
| Sample | | Material | coefficient | (nm) | Material | coefficient | (nm) | (%) | power (mW) | (%) |
| P | First information layer | — | — | — | TiO₂ | 0.05 | 5 | 1.9 | 8.2 | 6.7 |
| | Second information layer | — | — | — | TiO₂ | 0.05 | 9 | 2.8 | 5.2 | 6.1 |
| | Third information layer | — | — | — | TiO₂ | 0.05 | 15 | 2.9 | 4.8 | 5.7 |
| Q | First information layer | Fe₂O₃ | 0.8 | 5 | TiO₂ | 0.05 | 3 | — | — | — |
| | Second information layer | — | — | — | TiO₂ | 0.05 | 6 | 3.4 | 3.9 | 6.5 |
| | Third information layer | — | — | — | TiO₂ | 0.05 | 14 | 3.2 | 3.2 | 5.9 |

The other components of each of the samples P and Q were the same as those of Working Example 3.

As in Working Example 3, each of the samples P and Q was measured for the reflectivity (of an unrecorded portion), optimal recording power, and jitter of each of the first to third information layers 12, 14, and 52. Moreover, as in Working Example 3, the extinction coefficients of the first to third recording films 12R, 14R, and 52R were measured. The measurement results are also shown in Table 7.

As shown in Table 6, the sample K of Comparative Example 1 was designed such that the dielectric films of the first information layer had a small thickness of 5 nm and that the recording film of the first information layer had a large thickness of 52 nm, in order to increase the reflectivity of the first information layer. Unfortunately, the reflectivity of the first information layer was small, and the difference in reflectivity between the first and second information layers was large. Moreover, in the sample K, the optimal recording power of the first information layer was large, and the difference in optimal recording power between the first and second information layers was also large.

On the other hand, in the samples L and M, the difference in reflectivity between the first and second information layers was small, and the difference in optimal recording power between the first and second information layers was also small. However, the jitter values of the first information layer were 12.2% and 12.9% for the samples L and M, respectively. Namely, good reproducing characteristics were not obtained. It is conceivable that, in the sample L, good reproducing characteristics were not obtained because the first information layer did not have the light absorbing film. On the other hand, in the sample M, the first information layer had the light absorbing film. However, good reproducing characteristics were not obtained. This may be because the light absorbing film was formed of Ag and had an excessively lager extinction coefficient greater than 1.5, i.e., 4.0. The reason that Ag was used as the material forming the light absorbing film of the first information layer of the sample M is that the recording film contacting this light absorbing film was deposited by means of reactive sputtering using oxygen gas, and accordingly a material not oxidized during the reactive sputtering must be used as the material forming the light absorbing film.

In the sample N, the reflectivity of the first information layer was small, and the difference in reflectivity between the first and second information layers was large. In addition, the optimal recording power of the first information layer was large, and the difference in optimal recording power between the first and second information layers was large. This may be because the extinction coefficient of the second recording film of the second information layer was greater than 0.4, i.e., 0.57, so that the transmittance was small. Note that the optimal recording power of the first information layer can be reduced by increasing the thickness of the first recording film of the first information layer. However, this may cause a further reduction in the reflectivity of the first information layer. On the other hand, when the thickness of the first recording film of the first information layer is reduced, the reflectivity of the first information layer can be increased. However, the optimal recording power of the first information layer is further increased. Therefore, when such a material having a large extinction coefficient is used as the material forming the recording film, it is difficult to achieve a practically preferably design.

As shown in Table 7, in the sample P of Comparative Example 2, the optimal recording power of the first information layer was significantly greater than those of the second and third information layers. This may be because the first information layer did not have the light absorbing film.

In the sample Q of Comparative Example 2, the irradiation beam could not be focused on the first information layer. Therefore, the reflectivity, optimal recording power, and jitter of the first information layer could not be measured.

On the other hand, as shown in Tables 1 to 5, in the samples A to J of Working Examples 1 to 5, the extinction coefficient of each of the recording films was approximately 0.4 or less, i.e., 0.1 to 0.38, and the extinction coefficient of each of the light absorbing layers was approximately 1.5 or less, i.e., 0.5 to 1.4. In each case, the reflectivities of the plurality of information layers constituting each of the samples were detected by the photodetector 24 such that the detected values were close to each other. Moreover, in each of the samples A to J of Working Examples 1 to 5, the optimal recording powers of the plurality of information layers constituting each of the samples were close to each other. In addition, in each of the samples A to J of Working Examples 1 to 5, the jitter values of the plurality of information layers constituting each of the samples were 8% or less, so that good reproducing characteristics were obtained.

According to various exemplary embodiments of the present invention, it has been found that good recording marks can be formed equally in all the information layers by irradiating the plurality of information layers with a recording laser beam at the same output power level, even when a common material is used as the materials forming the recording films of the plurality of information layers. Furthermore, it has been found that the light beams reflected from the information layers are detected by a photodetector such that the detected intensities are close to each other, even when the information layers are irradiated with a reproducing laser beam at the same output power level.

What is claimed is:

1. An optical recording medium, comprising a plurality of information layers, each information layer including a recording film having an extinction coefficient of 0.4 or less at a wavelength of a laser beam used for recording and reproducing, the recording films consisting essentially of the same constituent elements, wherein
among the information layers, at least one information layer located further away from a laser beam-incident surface than an information layer located closest to the laser beam-incident surface further includes a light absorbing film having an extinction coefficient of 1.5 or less at the wavelength of the laser beam, the extinction coefficient of the light absorbing film being greater than that of the recording film.

2. An optical recording medium, comprising three or more information layers, each information layer including a recording film having an extinction coefficient of 0.2 or less at a wavelength of a laser beam used for recording and reproducing, the recording films consisting essentially of the same constituent elements, wherein
among the information layers, at least one information layer located further away from a laser beam-incident surface than an information layer located closest to the laser beam-incident surface further includes a light absorbing film having an extinction coefficient of 1.5 or less at the wavelength of the laser beam, the extinction coefficient of the light absorbing film being greater than that of the recording film.

3. The optical recording medium according to claim 1, wherein the extinction coefficient of the light absorbing film is 0.3 or more.

4. The optical recording medium according to claim 2, wherein the extinction coefficient of the light absorbing film is 0.3 or more.

5. The optical recording medium according to claim 1, wherein the recording film consists essentially of Bi, O, and M where M is at least one element selected from the group consisting of Mg, Ca, Y, Dy, Ce, Tb, Ti, Zr, V, Nb, Ta, Mo, W, Mn, Fe, Zn, Al, In, Si, Ge, Sn, Sb, Li, Na, K, Sr, Ba, Sc, La, Nd, Sm, Gd, Ho, Cr, Co, Ni, Cu, Ga, and Pb, and a ratio of number of O atoms to number of is all atoms constituting the recording film is 62% or more.

6. The optical recording medium according to claim 2, wherein the recording film consists essentially of Bi, O, and M where M is at least one element selected from the group consisting of Mg, Ca, Y, Dy, Ce, Tb, Ti, Zr, V, Nb, Ta, Mo, W, Mn, Fe, Zn, Al, In, Si, Ge, Sn, Sb, Li, Na, K, Sr, Ba, Sc, La, Nd, Sm, Gd, Ho, Cr, Co, Ni, Cu, Ga, and Pb, and a ratio of number of O atoms to number of all atoms constituting the recording film is 62% or more.

7. The optical recording medium according to claim 3, wherein the recording film consists essentially of Bi, O, and M where M is at least one element selected from the group consisting of Mg, Ca, Y, Dy, Ce, Tb, Ti, Zr, V, Nb, Ta, Mo, W, Mn, Fe, Zn, Al, In, Si, Ge, Sn, Sb, Li, Na, K, Sr, Ba, Sc, La, Nd, Sm, Gd, Ho, Cr, Co, Ni, Cu, Ga, and Pb, and a ratio of number of O atoms to number of all atoms constituting the recording film is 62% or more.

8. The optical recording medium according to claim 1, wherein the recording film consists essentially of Bi and O, and a ratio of number of O atoms to number of all atoms constituting the recording film is 62% or more.

9. The optical recording medium according to claim 2, wherein the recording film consists essentially of Bi and O, and a ratio of number of O atoms to number of all atoms constituting the recording film is 62% or more.

10. The optical recording medium according to claim 3, wherein the recording film consists essentially of Bi and O, and a ratio of number of O atoms to number of all atoms constituting the recording film is 62% or more.

11. The optical recording medium according to claim 5, wherein the recording film consists essentially of Bi and O, and a ratio of number of O atoms to number of all atoms constituting the recording film is 62% or more.
